(19) United States
(12) Patent Application Publication
(10) Pub. No.: US 2013/0176960 A1
(43) Pub. Date: Jul. 11, 2013

(54) APPARATUS AND METHOD FOR COGNITIVE RADIO MESH NETWORK BASED ON GEOLOCATION DATABASE

(71) Applicant: Electronics And Telecommunications Research Institute, Daejeon (KR)

(72) Inventors: Antony A. FRANKLIN, Tami Nadu (IN); Jin Suk PAK, Daejeon (KR); Gwang Zeen KO, Daejeon (KR); Sung Jin YOO, Daejeon (KR); Byung Jang JEONG, Daejeon (KR)

(73) Assignee: ELECTRONICS AND TELECOMMUNICATIONS RESEARCH INSTITUTE, Daejeon (KR)

(21) Appl. No.: 13/734,213

(22) Filed: Jan. 4, 2013

(30) Foreign Application Priority Data
Jan. 6, 2012 (KR) 10-2012-0001906

(51) Int. Cl. H04W 72/04

(52) U.S. Cl. CPC H04W 72/046
USPC 370/329

(57) ABSTRACT

A cognitive radio mesh node may include at least one directional antenna, at least one transceiver to transmit and receive data using the at least one directional antenna, and a processor to determine a channel for performing communication for a cognitive radio mesh network based on a geolocation database and to control the at least one transceiver based on the determined channel.

### CROSS-REFERENCE TO RELATED APPLICATION

This application claims the priority benefit of Korean Patent Application No. 10-2012-0001906, filed on Jan. 6, 2012, in the Korean Intellectual Property Office, the disclosure of which is incorporated herein by reference.

### BACKGROUND

1. Field of the Invention

Exemplary embodiments of the present invention relate to an apparatus and method for a cognitive radio mesh network based on a geolocation database.

2. Description of the Related Art

A radio mesh network refers to an architecture for a radio backhaul network using a multi-hop environment. The radio mesh network may include mesh nodes installed on, for example, a roof, a utility pole, and the like. Since the mesh nodes are fixed, a topology of the radio mesh network using the mesh nodes may be static.

Using a cognitive radio technology, the radio mesh network may provide a wireless Internet connection efficiently in an area in which radio resource usage is insufficient. That is, an underused radio resource may be used at random in an unlicensed manner. The radio mesh network using the cognitive radio technology may greatly reduce an initial cost for providing an Internet service, for example, an infrastructure installation cost for providing an Internet service.

### SUMMARY

According to an aspect of the present invention, there is provided a mesh node used in a cognitive radio mesh network, the mesh node including at least one directional antenna, at least one transceiver to transmit and receive data using the at least one directional antenna, and a processor to determine a channel for performing communication for the cognitive radio mesh network based on a geolocation database and to control the at least one transceiver based on the determined channel, and the geolocation database may include information about a plurality of present users located in a service area of the cognitive radio mesh network.

The cognitive radio mesh network may include at least one gateway node with an Internet connection, and the processor may access a server including the geolocation database through the Internet connection using the at least one gateway node.

The server may provide information about an available channel for the cognitive radio mesh network based on the information about the plurality of present users, in response to a request by the processor, and the processor may select the channel for performing communication based on the information provided about the available channel.

The request may include at least one of a direction of the at least one directional antenna, a width of a beam radiated by the at least one directional antenna, a radiation pattern of the at least one directional antenna, and a transmission power of the at least one directional antenna.

The processor may determine the channel for performing communication by excluding a channel being used by a present user located in an interference area of the at least one directional antenna, based on at least one of the direction of the at least one directional antenna, the width of the beam radiated by the at least one directional antenna, the radiation pattern of the at least one directional antenna, and the transmission power of the at least one directional antenna.

The mesh node may further include an antenna direction adjusting unit to adjust a direction of the at least one directional antenna, the processor may determine the direction of each of the at least one directional antenna based on a topology and may control the antenna direction adjusting unit based on the determined direction, and the topology may include information about at least one neighboring mesh node adjacent to each of a plurality of mesh nodes included in the cognitive radio mesh network.

According to another aspect of the present invention, there is provided a method of operating a cognitive radio mesh node using a geolocation database, the method including determining at least one of whether the mesh node is a gateway node, whether the mesh node to has an Internet connection, and whether the mesh node is connected to at least one neighboring mesh node adjacent to the mesh node, enabling an Internet connection of the mesh node based on the determined result, connecting the mesh node to the at least one neighboring mesh node based on the determined result and the geolocation database, and maintaining a connection between the mesh node and the at least one neighboring mesh node based on the determined result and the geolocation database, and the geolocation database may be accessed via an Internet connection and may include information about a plurality of present users located in a service area of a cognitive radio mesh network.

The enabling of the Internet connection may include sensing a beacon signal transmitted by one of the at least one neighboring mesh node adjacent to the mesh node, transmitting information about a channel being used by at least one neighboring mesh node adjacent to the mesh node to the neighboring mesh node transmitting the beacon signal, based on the sensing result, receiving a response associated with the determining of the channel from the neighboring mesh node transmitting the beacon signal, and enabling the Internet connection of the mesh node based on the received response.

Each of the connecting to the at least one neighboring mesh node and the maintaining of the connection may include obtaining a plurality of available channels between the mesh node and a neighboring mesh node to be connected to, using the geolocation database, selecting one of the plurality of available channels by excluding a channel being used by at least one neighboring mesh node adjacent to the mesh node, transmitting, using the selected channel, a beacon signal to the neighboring mesh node to be connected to, receiving information about a channel being used by at least one neighboring mesh node adjacent to the neighboring mesh node to be connected to, from the neighboring mesh node to be connected to, and determining a channel between the mesh node and the neighboring mesh node to be connected to, based on the received information.

The connecting to the at least one neighboring mesh node may further include determining whether the mesh node is connected to the at least one neighboring node, and the maintaining of the connection may further include determining whether the connection between the mesh node and the at least one neighboring node is available.

The mesh node may include at least one directional antenna, and the connecting to the at least one neighboring mesh node may further include connecting to the at least one neighboring mesh node based on at least one of a direction of the at least one directional antenna, a width of a beam radiated by the at least one directional antenna, a radiation pattern of the at least one directional antenna, and a transmission power of the at least one directional antenna, and the maintaining of the connection may further include maintaining the connection based on at least one of a direction of the at least one directional antenna, a width of a beam radiated by the at least one directional antenna, a radiation pattern of the at least one directional antenna, and a transmission power of the at least one directional antenna.

The method may further include determining a direction of each of the at least one directional antenna based on a topology, and the topology may include information about the at least one neighboring mesh node adjacent to the mesh node.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a cognitive radio mesh network architecture according to an embodiment of the present invention;

FIGS. 2A and 2B are diagrams illustrating an interference area of an omni-directional antenna and an interference area of a directional antenna according to an embodiment of the present invention;

FIG. 3 is a diagram illustrating a radiation pattern of a directional antenna according to an embodiment of the present invention;

FIG. 4 is a block diagram illustrating a cognitive radio mesh node according to an embodiment of the present invention;

FIG. 5 is a flowchart illustrating a method of operating a cognitive radio mesh node according to an embodiment of the present invention;

FIG. 6 is a flowchart illustrating a method of enabling an Internet connection of a mesh node according to an embodiment of the present invention;

FIG. 7 is a flowchart illustrating a method of establishing a connection between a mesh node and a neighboring mesh node adjacent to the mesh node according to an embodiment of the present invention;

FIG. 8 is a flowchart illustrating a method of maintaining a connection between a mesh node and a neighboring mesh node adjacent to the mesh node according to an embodiment of the present invention; and

FIG. 9 is a flowchart illustrating a method of selecting a channel for establishing and maintaining a connection between a cognitive radio mesh node and a neighboring node according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

1. Cognitive Radio Mesh Network

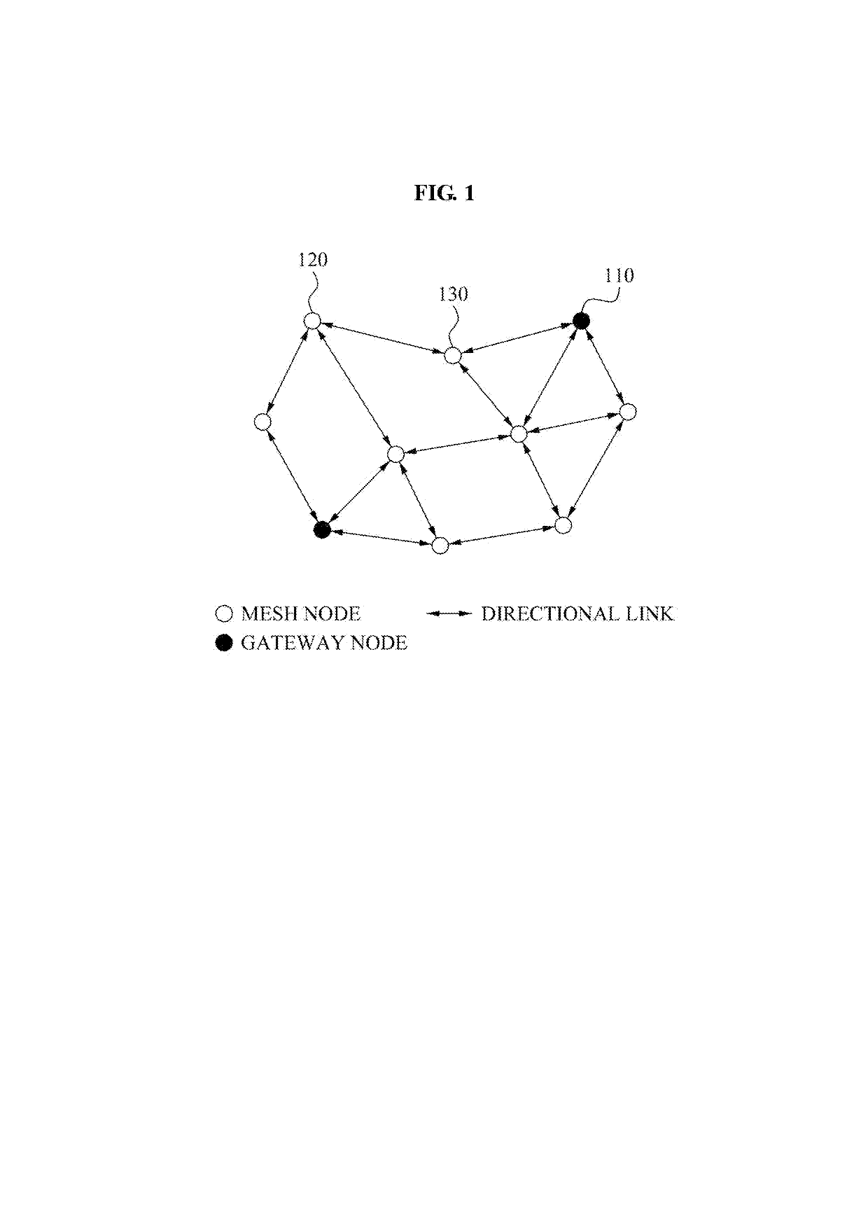

FIG. 1 is a diagram illustrating a cognitive radio mesh network architecture according to an embodiment of the present invention.

Referring to FIG. 1, a cognitive radio mesh network according to an embodiment of to the present invention may include at least one gateway node 110 having a wired or wireless Internet connection. In this instance, the cognitive radio mesh network may access a geolocation database on the Internet through the wired or wireless Internet connection, using the gateway node 110. Further, the cognitive radio mesh network according to an embodiment of the present invention may provide a technology for protecting present users using the geolocation database. A detailed description of the technology for protecting present users is provided later.

Also, a cognitive radio mesh node according to an embodiment of the present invention may include at least one directional antenna. The mesh node may adjust a direction of each of at least one directional antenna. As described in the foregoing, since a topology of the cognitive radio mesh network according to an embodiment of the present invention may be static, in advance of communication using the radio mesh network, a direction of at least one directional antenna of each of a plurality of mesh nodes included in the radio mesh network may be set based on a pre-calculated topology. For example, directions of antennas of a mesh node 120 and a mesh node 130 may be set such that the antennas face one another to establish a communication between the mesh node 120 and the mesh node 130.

In this instance, the cognitive radio mesh node invention may include a plurality of transceivers, for example, a first transceiver and a second transceiver. In this instance, the first transceiver may transmit and receive data using a first directional antenna and the second transceiver may transmit and receive data using a second directional antenna, and the first directional antenna and the second directional antenna may be different. The cognitive radio mesh node according to an embodiment of the present invention may improve a networking capacity using the plurality of transceivers. For example, the mesh node 130 may communicate with the mesh node 120 using the first transceiver and the first directional antenna, and may communicate with the gateway node 110 using the second transceiver and the second directional antenna.

2. Directional Antenna

To use a radio spectrum at random, protecting operations of present users on the spectrum in the cognitive radio network is required. For example, a need to prevent generation of an interference signal affecting present users adversely in the cognitive radio network may be present.

The cognitive radio network according to an embodiment of the present invention may reduce an interference area and may improve a function of protecting present users, using a directional antenna. Further, the cognitive radio network according to an embodiment of the present invention may increase a number of free channels for the cognitive radio network, using the directional antenna.

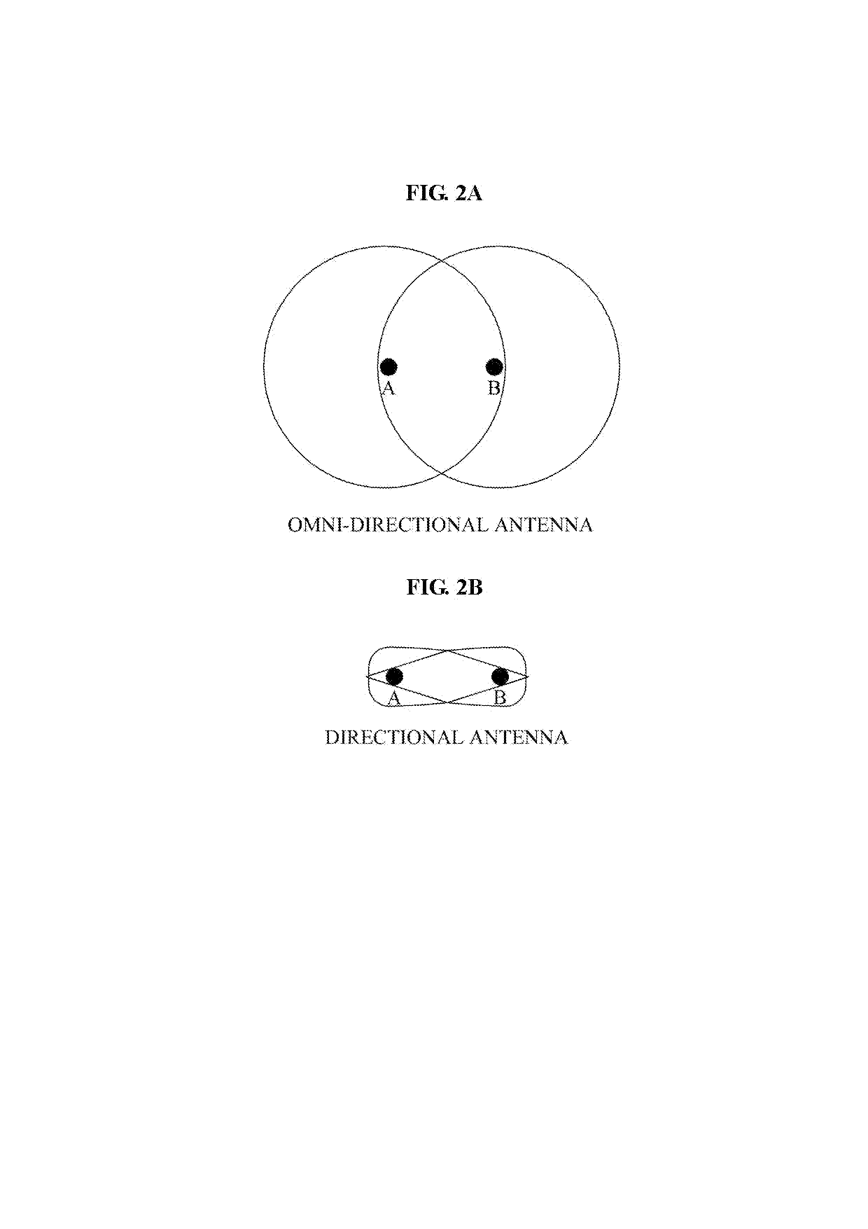

FIGS. 2A and 2B are diagrams illustrating an interference area of an omni-directional antenna and an interference area of a directional antenna according to an embodiment of the present invention.

Referring to FIGS. 2A and 2B, when communication is established between a node A and a node B, an interference area may be formed based on a transmission range of an antenna. In this instance, an interference area in a case in which the node A and the node B use directional antennas as shown in FIG. 2B may be remarkably reduced, when compared to an interference area in a case in which the node A and the node B use omni-directional antennas as shown in FIG. 2A.

The cognitive radio mesh node according to an embodiment of the present invention may operate by excluding a channel being used by a present user located in an interference area to protect operations of present users. Accordingly, the cognitive radio mesh node according to an embodiment of the present invention may increase a number of available channels for the cognitive radio network, using the directional antenna.

3. Geolocation Database

The cognitive radio mesh node according to an embodiment of the present invention may use a geolocation database to support the directional antenna. In this instance, the geolocation database may provide a list of available channels in the cognitive radio network.

In particular, the geolocation database may include information about present users located in a service area of the cognitive radio network, for example, channel information, time information, location information, and range information. The geolocation database according to an embodiment of the present invention may be provided by a radio regulation authority, for example, the Federal Communications Commission (FCC) in the U.S.A. In this instance, a contour of a radio resource to be protected may be different based on a location in which each present user is provided with a service.

The cognitive radio mesh node according to an embodiment of the present invention may request, from the geolocation database, a list of channels available at a location in which communication is to be performed. In this instance, the list of available channels may depend on a maximum transmission power of the cognitive radio mesh node. Accordingly, the radio regulation authority may determine a maximum transmission power of the cognitive radio mesh node based on whether the cognitive radio mesh node is a fixed type or a mobile type.

Also, the cognitive radio network according to an embodiment of the present invention may adjust the directional antenna using the geolocation database. For example, the cognitive radio mesh node may obtain a list of channels available at a location in which communication is to be performed, based on whether an operation mode of the cognitive radio mesh node is a fixed type or a mobile type, using the geolocation database. When the operation mode of the cognitive radio mesh node is a fixed type, the cognitive radio mesh node may use a direction of the directional antenna, a width of a beam from the directional antenna, and a radiation pattern of the directional antenna, to obtain the list of available channels.

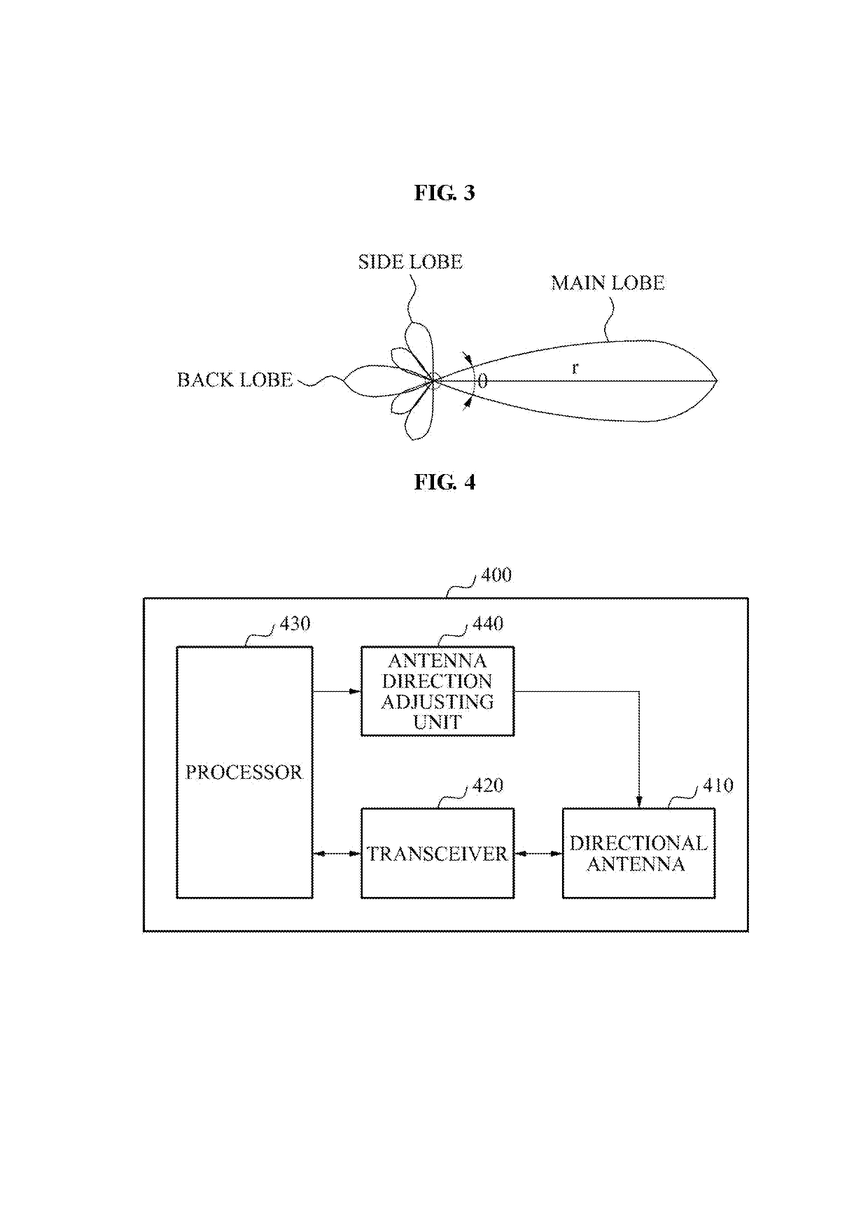

FIG. 3 is a diagram illustrating the radiation pattern of the directional antenna according to an embodiment of the present invention.

4. Cognitive Radio Mesh Node

FIG. 4 is a block diagram illustrating a cognitive radio mesh node 400 according to an embodiment of the present invention.

Referring to FIG. 4, the cognitive radio mesh node 400 according to an embodiment of the present invention may include at least one directional antenna 410, at least one transceiver 420, and a processor 430.

In this instance, the at least one transceiver 420 may transmit and receive data using the at least one directional antenna 410, and the processor 430 may determine a channel for performing communication for the cognitive radio mesh network based on a geolocation database, and may control the at least one transceiver 420 based on the determined channel.

As an example, the geolocation database may include information about a plurality of present users located in a service area of the cognitive radio mesh network. As described in the foregoing with reference to FIG. 1, the cognitive radio mesh network may include at least one gateway node with an Internet connection, and the processor 430 may access a server including the geolocation database via the Internet through the at least one gateway node.

According to an embodiment of the present invention, the server may provide information about an available channel for the cognitive radio mesh network based on the information about the plurality of present users, in response to a request by the processor 430, and the processor 430 may determine a channel for performing communication based on the information provided about the available channel. Here, the request may include at least one of a direction of the at least one directional antenna 410, a width of a beam radiated by the at least one directional antenna 410, a radiation pattern of the at least one directional antenna 410, and a transmission power of the at least one directional antenna 410.

According to another embodiment of the present invention, the processor 430 may further determine a channel for performing communication based on at least one of the direction of the at least one directional antenna 410, the width of the beam radiated by the at least one directional antenna 410, the radiation pattern of the at least one directional antenna 410, and the transmission power of the at least one directional antenna. For example, the processor 430 may determine the channel for performing communication by excluding a channel being used by a present user located in an interference area of the at least one directional antenna 410 based on the factors to be considered.

Also, the cognitive radio mesh node 400 according to an embodiment of the present invention may further include an antenna direction adjusting unit 440 to adjust a direction of the at least one directional antenna 410. In this instance, the processor 430 may determine a direction of each of the at least one directional antenna 410 based on a topology, and may control the antenna direction adjusting unit 440 based on the determined direction. Here, the topology may include information about at least one neighboring mesh node adjacent to each of a plurality of mesh nodes included in the cognitive radio mesh network.

5. Method of Operating a Cognitive Radio Mesh Node

(1) Method of Establishing Communication Channel of Cognitive Radio Mesh Network

The cognitive radio mesh node according to an embodiment of the present invention may set a direction of a directional antenna such that the direction antenna faces a location of a neighboring node to implement a topology. The cognitive radio mesh network according to an embodiment of the present invention may determine a channel for performing communication between a plurality of cognitive radio mesh nodes.

In this case, the cognitive radio mesh network according to an embodiment of the present invention may protect present users using a geolocation database. In this instance, the cognitive radio mesh node according to an embodiment of the present invention may to access a geolocation database via an Internet connection.

A plurality of cognitive radio mesh nodes included in the cognitive radio mesh network according to an embodiment of the present invention may be unable to access a direct Internet connection. In such a case, a cognitive radio mesh node in which a direct Internet connection is absent, may fail to obtain information about available channels for performing communication until the cognitive radio mesh node accesses a geolocation database via an Internet connection.

Accordingly, the cognitive radio mesh network according to an embodiment of the present invention may include at least one gateway node with a direct Internet connection. The cognitive radio mesh network according to an embodiment of the present invention may perform an initiation operation using the at least one gateway node.

For example, since the gateway node according to an embodiment of the present invention accesses a geolocation database via an Internet connection, the gateway node may obtain a list of available channels and information about neighboring nodes. The gateway node may allocate a channel for performing communication to neighboring nodes using the list and the information about the neighboring nodes.

By the gateway node allocating a channel for performing communication to neighboring nodes of the gateway node, the neighboring node may have an Internet connection in a multi-hop manner through the gateway node. In this case, the neighboring nodes of the gateway node may access the geolocation database, and may allocate a channel for performing communication to neighboring nodes adjacent to the neighboring nodes.

In this manner, a plurality of cognitive radio mesh nodes included in the cognitive radio mesh network according to an embodiment of the present invention may be allocated to a channel for performing communication.

Further, the cognitive radio mesh network according to an embodiment of the present invention may use a media access control (MAC) protocol including a beacon mechanism to maintain a networking operation. Accordingly, the cognitive radio mesh node according to an embodiment of the present invention may detect beacon signals from all channels in a round robin method upon being powered-on.

(2) Method of Selecting Channel

According to an embodiment of the present invention, the cognitive radio mesh node having an Internet connection through a gateway node may obtain a list of available channels from a geolocation database. After the cognitive radio mesh node according to an embodiment of the present invention obtains the list of available channels, the cognitive radio mesh node may select a channel for performing communication with a neighboring node by a method of selecting a channel described below.

By way of example, in a method of selecting a channel for performing communication between a mesh node P and a mesh node Q, the mesh node P has an Internet connection and the mesh node Q corresponds to a neighboring node of the mesh node P. Accordingly, the mesh node P may select a channel for performing communication between the mesh node P and the mesh node Q.

The mesh node P may provide a geolocation database with information, for example, geolocation information and a width of a beam radiated by a directional antenna of each of the mesh node P and the mesh node Q. In this case, the mesh node P may obtain a list of available channels for performing communication between the mesh node P and the mesh node Q.

In this instance, the mesh node P may select a channel X for communication between the mesh node P and the mesh node Q by excluding a channel being used by another neighboring node. The mesh node P may transmit a beacon signal to the mesh node Q using the channel X.

The mesh node Q may detect the beacon signal transmitted from the mesh node P in the channel X. The mesh node Q may transmit an acknowledgement (ACK) signal indicating detection of the beacon signal and information about a channel being used by a neighboring node of the mesh node Q.

The mesh node P may determine whether the selected channel X is being used by the neighboring node of the mesh node Q. When the selected channel X corresponds to a channel unused by the neighboring node of the mesh node Q, the mesh node P may transmit, to the mesh node Q, a signal indicating that the channel X is determined to be a channel for performing communication between the mesh node P and the mesh node Q.

Conversely, when the determined channel X is being used by the neighboring node of the mesh node Q, the mesh node P may select another channel Y by excluding the channel being used by the neighboring node of the mesh node Q. In this case, the mesh node P may transmit, to the mesh node Q, a signal indicating that the channel for communication is changed to the channel Y.

When all the available channels for performing communication between the mesh node P and the mesh node Q are being used by neighboring nodes of the mesh node P and neighboring nodes of the mesh node Q, the mesh node P may determine to continue to use the channel X. In this case, the channel X may be shared to perform at least one communication.

(3) Method of Maintaining Cognitive Radio Mesh Network

Since the cognitive radio mesh network according to an embodiment of the present invention selects a channel for performing communication at random, a list of available channels may be changed over time. Accordingly, the cognitive radio mesh node according to an embodiment of the present invention may verify whether the selected channel is available during a predetermined time interval. In this instance, whether the selected channel is available may be determined based on whether a cognitive radio communication using the selected channel may cause adverse interference to present users.

In this instance, the cognitive radio mesh node according to an embodiment of the present invention may verify whether the selected channel is available, using a geolocation database. When the selected channel is determined to be unavailable, that is, when the selected channel is determined to cause adverse interference to the present users, the cognitive radio mesh node according to an embodiment of the present invention may select a new channel for performing communication by the same method as the foregoing method of selecting a channel.

(4) Method of Operating Cognitive Radio Mesh Node

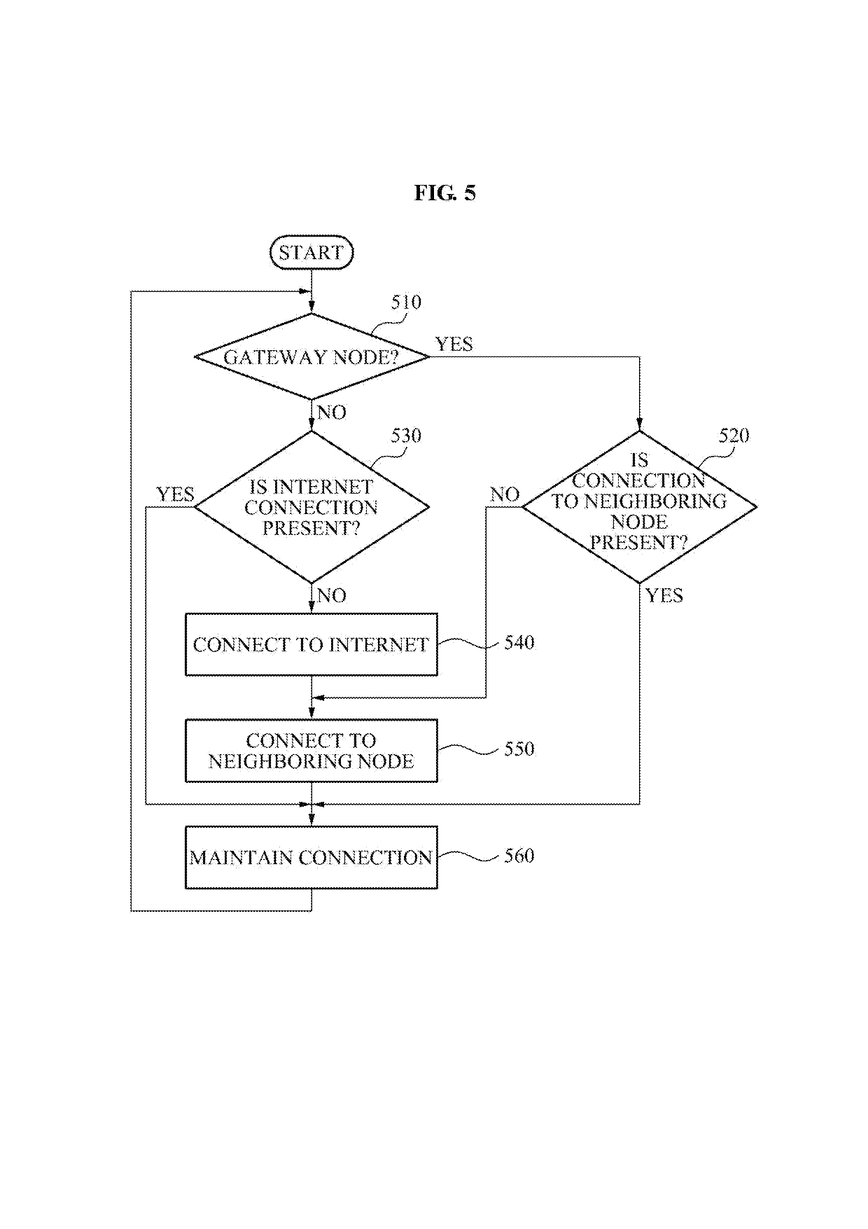

Hereinafter, a method of operation the cognitive radio mesh node according to an embodiment of the present invention is described in detail with reference to FIGS. 5 through 9.

FIG. 5 is a flowchart diagram illustrating a method of operating the cognitive radio mesh node according to an embodiment of the present invention.

Referring to FIG. 5, the cognitive radio mesh node according to an embodiment of the present invention may determine whether the mesh node corresponds to a gateway node in operation 510.

When the mesh node is determined to be a gateway node, the mesh node may determine whether the mesh node is connected to a neighboring node adjacent to the mesh node in operation 520. When it is determined that the mesh node corresponds to a gateway node and fails to be connected to the neighboring node, the mesh node may establish a connection with the neighboring node in operation 550.

When the mesh node is determined not to be a gateway node, the mesh node may determine whether the mesh node has an Internet connection in operation 530, and when the mesh node fails to have an Internet connection, the mesh node may enable an Internet connection in a multi-hop manner in operation 540.

When the mesh node is determined to be a gateway node and is connected to a neighboring node, or when the mesh node is determined not to be a gateway node and has an Internet connection, the mesh node may maintain a connection with the neighboring node in operation 560.

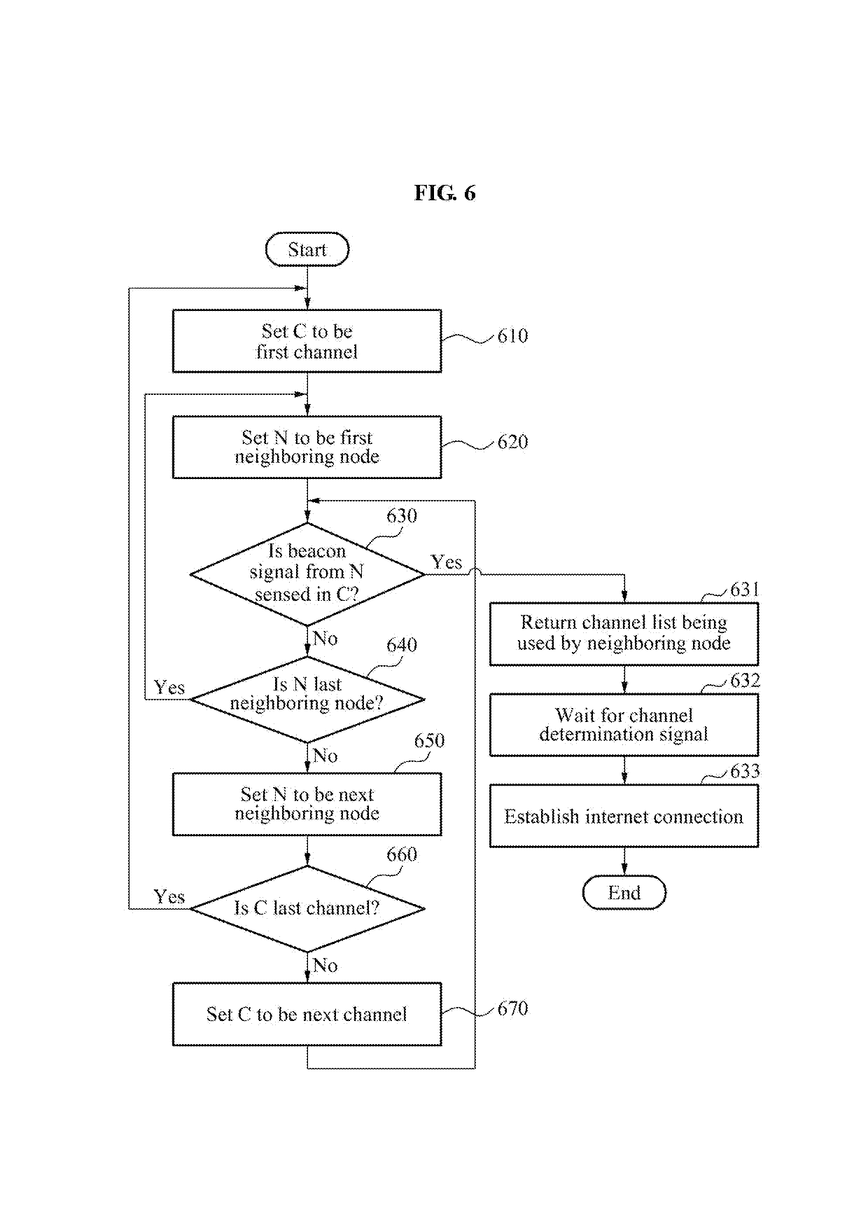

Hereinafter, the operation 540 of enabling an Internet connection, the operation 550 of establishing a connection to the neighboring node, and the operation 560 of maintaining the connection are described with reference to FIGS. 6 through 9.

FIG. 6 is a flowchart illustrating a method of enabling an Internet connection of the mesh node according to an embodiment of the present invention.

Referring to FIG. 6, the mesh node according to an embodiment of the present invention may verify whether a beacon signal is detected in a plurality of available channels, from a first channel to a last channel in sequential order, in operations 610, 660, and 670. In this instance, the mesh node according to an embodiment of the present invention may verify whether a beacon signal is transmitted from a neighboring node in each channel, from a first neighboring node to a last neighboring node in order, in operations 620, 640, and 650

For example, the mesh node according to an embodiment of the present invention may detect a beacon signal transmitted from a neighboring node N in a channel C, in operation 630. Since the neighboring node N transmits the beacon signal when the neighboring node N corresponds to a gateway node, or when the neighboring node N fails to correspond to a gateway node and has an Internet connection, the mesh node may enable an Internet connection by communicating with the neighboring node N using the channel C.

In this instance, the mesh node according to an embodiment of the present invention may return a list of channels being used by a neighboring node of the mesh node to the neighboring node N, in operation 631. In this case, the neighboring node N may determine whether the channel C is being used by a neighboring node of the mesh node, and may determine a channel for performing communication between the neighboring node N and the mesh node based on the determined result. The neighboring node N may transmit a signal associated with the determined channel to the mesh node in operation 632.

The mesh node according to an embodiment of the present invention may enable an Internet connection through the neighboring node N based on the signal associated with the determined channel in operation 633.

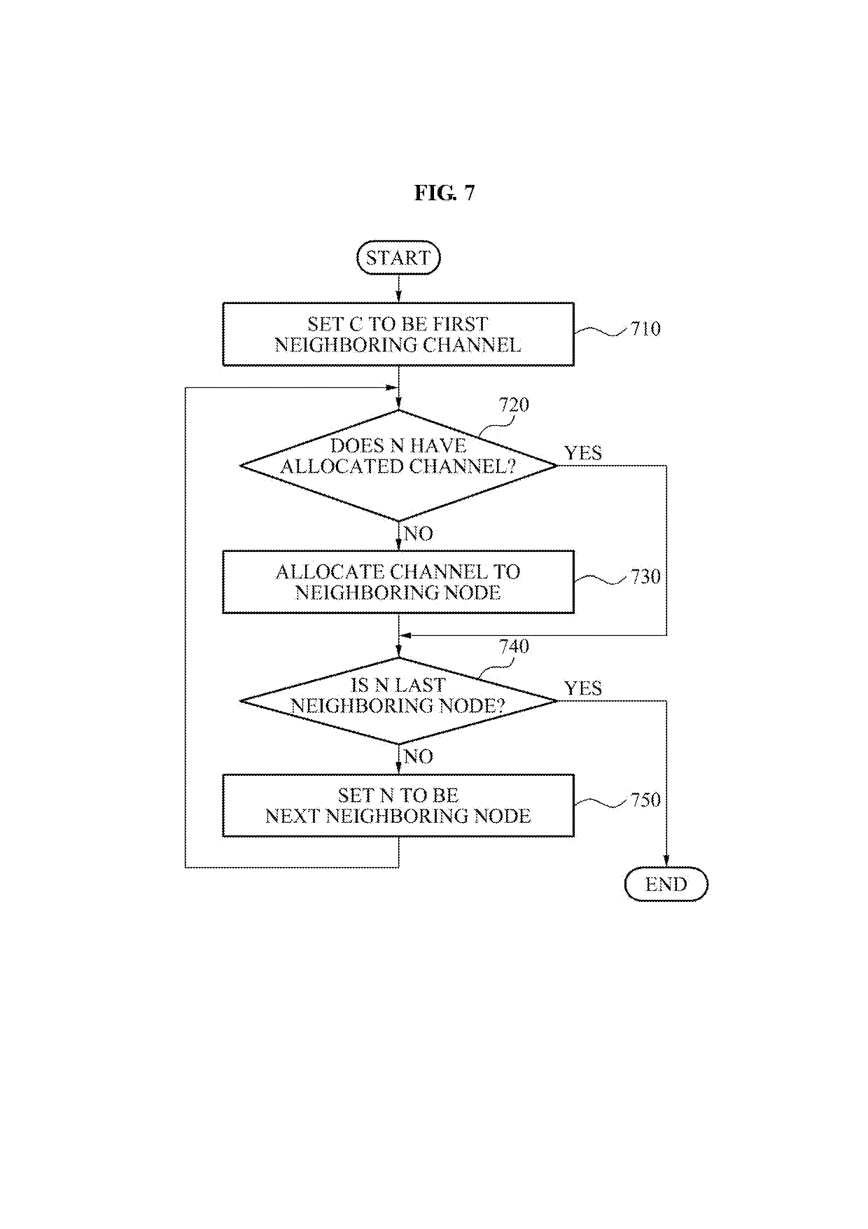

FIG. 7 is a flowchart illustrating a method of establishing a connection between the mesh node and the neighboring mesh node adjacent to the mesh node according to an embodiment of the present invention.

Referring to FIG. 7, the mesh node according to an embodiment of the present invention may be in an Internet connection state, and may establish a connection to the neighboring mesh node. That is, the mesh node according to an embodiment of the present invention may access a geolocation database via an Internet to obtain a list of available channels for performing communication with the neighboring node while preventing harmful interference from occurring to present users, and may establish a connection to the neighboring node using the list.

The mesh node according to an embodiment of the present invention may verify whether a channel for performing communication is allocated to neighboring nodes from a first neighboring node to a last neighboring node in sequential order, in operations 710, 720, 740, and 750. When the mesh node according to an embodiment of the present invention detects a neighboring node that fails to be allocated to a channel for performing communication, among the plurality of neighboring nodes, the mesh node may allocate a channel for performing communication to the neighboring node in operation 730.

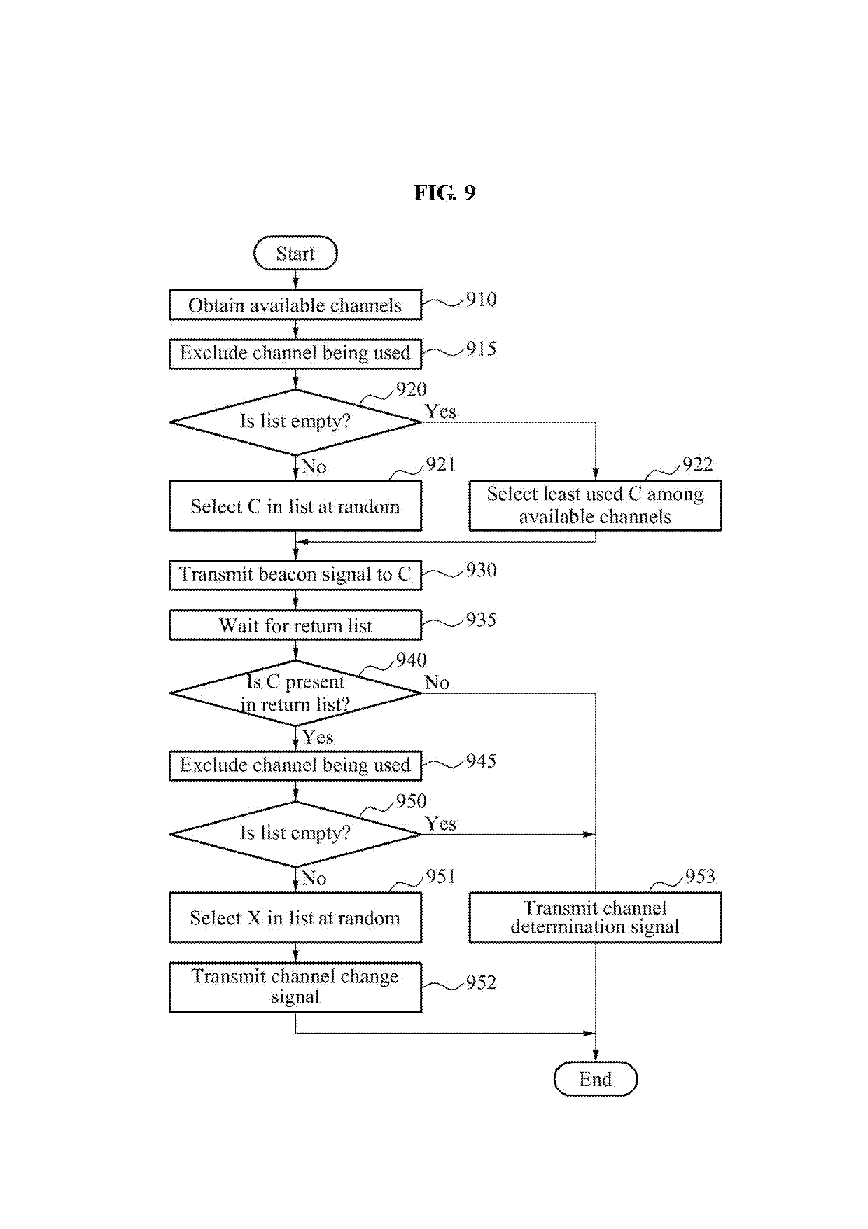

Hereinafter, the operation 730 of allocating a channel for performing communication to the neighboring node is described with reference to FIG. 9.

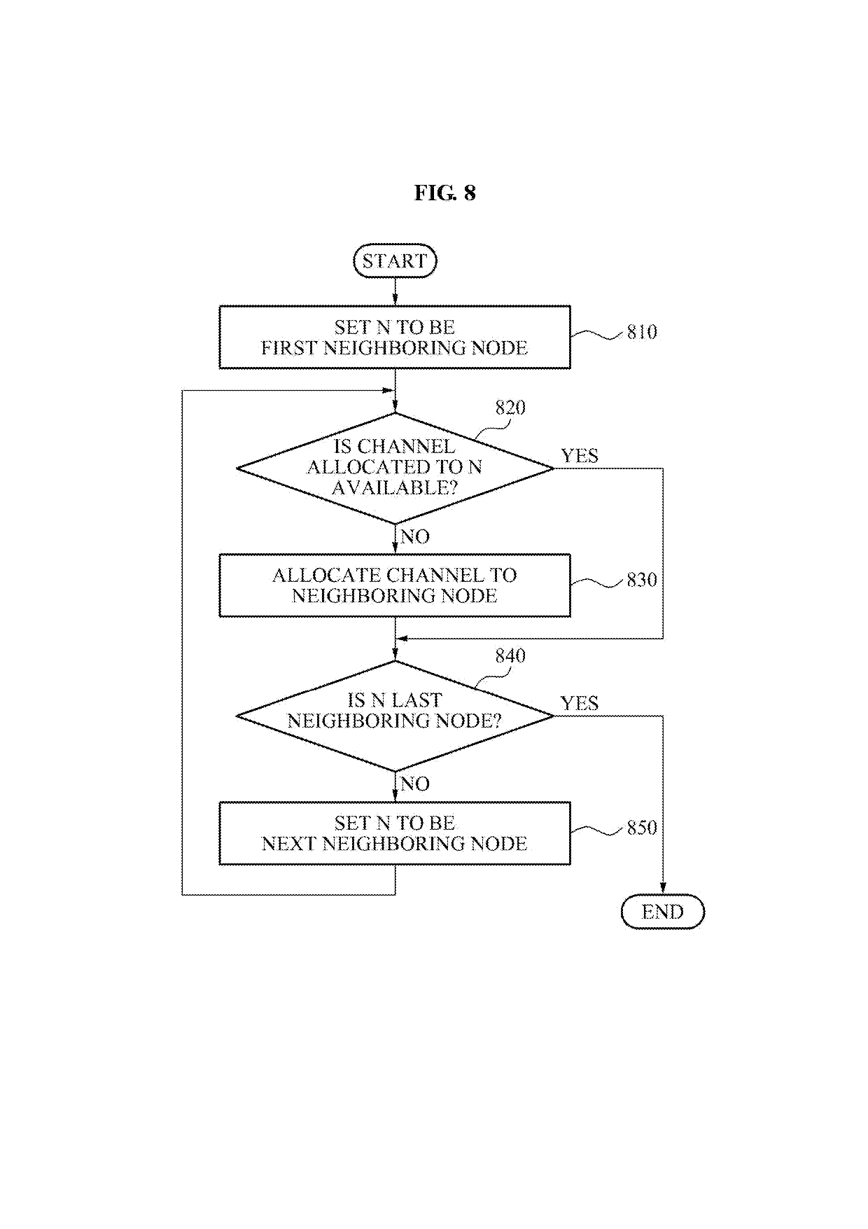

FIG. 8 is a flowchart illustrating operations of a method of maintaining a connection between the mesh node and the neighboring mesh node adjacent to the mesh node according to an embodiment of the present invention.

Referring to FIG. 8, the mesh node according to an embodiment of the present invention may verify whether the allocated channel for performing communication is available, for neighboring nodes adjacent to the mesh node from a first neighboring node to a last neighboring node in order, in operations 810, 820, 840, and 850. When a neighboring node having an unavailable channel allocated for performing communication is detected among the plurality of neighboring nodes, the mesh node according to an embodiment of the present invention may allocate a new channel for performing communication to the neighboring node in operation 830.

Here, the operation 830 of allocating a new channel for performing communication to the neighboring node is described with reference to FIG. 9.

FIG. 9 is a flowchart illustrating operations of a method of selecting a channel for establishing and maintaining a connection between the cognitive radio mesh node and the neighboring node according to an embodiment of the present invention.

Referring to FIG. 9, in operation 910, the cognitive radio mesh node according to an embodiment of the present invention may access a geolocation database via an Internet connection to obtain a list of available channels for performing communication with the neighboring node while preventing harmful interference from occurring to present users. In operation 915, the mesh node according to an embodiment of the present invention may exclude a channel being used by a neighboring node adjacent to the mesh node from the list of available channels. In this instance, the mesh node according to an embodiment of the present invention may determine whether an available channel (C) is present in the list of available channels excluding the channel being used, in operation 920.

When the available C is absent in the list of available channels excluding the channel being used, the mesh node according to an embodiment of the present invention may select a least allocated C among the available Cs in operation 922. In this instance, at least two neighboring nodes may share the selected C.

Conversely, when an available C is present in the list of available Cs excluding the channel being used, the mesh node according to an embodiment of the present invention may select one of the available channels at random in operation 921.

The mesh node according to an embodiment of the present invention may transmit a beacon signal to the selected C in operation 930, and may be in a waiting state while monitoring whether a response from the corresponding channel is present, in operation 935. In this instance, the response from the corresponding channel may include a list of channels being used by a second neighboring node adjacent to a first neighboring node transmitting the response.

In this case, the mesh node according to an embodiment of the present invention may verify whether the selected channel is present in the list received in response, in operation 940, and when the selected channel is absent in the list received in response, the mesh node may transmit a signal indicating that the selected C is determined to be a communication channel in operation 953.

When the selected C is present in the list received in response, the mesh node according to an embodiment of the present invention may exclude the C present in the list received in response from the list of available channel in operation 945. In this instance, the mesh node according to an embodiment of the present invention may re-determine whether an available C is present in the list of available Cs excluding the C being used, in operation 950.

When an available C is determined to be absent in the list of the available Cs excluding the channel being used, the mesh node according to an embodiment of the present invention may transmit a signal indicating that the already selected C continues to be used, in operation 953. In this instance, at least two neighboring nodes may share the already selected C.

Conversely, when an available C is present in the list of available Cs excluding the C being used, the mesh node according to an embodiment of the present invention may select one of the available Cs at random, in operation 951, and may transmit a signal indicating that a C for performing communication is determined to be changed to the randomly selected C, in operation 952.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard discs, floppy discs, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A mesh node used in a cognitive radio mesh network, the mesh node comprising:
at least one directional antenna;
at least one transceiver to transmit and receive data using the at least one directional antenna; and
a processor to determine a channel for performing communication for the cognitive radio mesh network based on a geolocation database and to control the at least one transceiver based on the determined channel,
wherein the geolocation database includes information about a plurality of present users located in a service area of the cognitive radio mesh network.

2. The mesh node of claim 1, wherein the cognitive radio mesh network includes at least one gateway node with an Internet connection, and
the processor accesses a server including the geolocation database through the Internet connection using the at least one gateway node.

3. The mesh node of claim 2, wherein the server provides information about an available channel for the cognitive radio mesh network based on the information about the plurality of present users, in response to a request by the processor, and
the processor selects the channel for performing communication based on the information provided about the available channel.

4. The mesh node of claim 3, wherein the request includes at least one of a direction of the at least one directional antenna, a width of a beam radiated by the at least one directional antenna, a radiation pattern of the at least one directional antenna, and a transmission power of the at least one directional antenna.

5. The mesh node of claim 1, wherein the processor determines the channel for performing communication by excluding a channel being used by a present user located in an interference area of the at least one directional antenna, based on at least one of the direction of the at least one directional antenna, the width of the beam radiated by the at least one directional antenna, the radiation pattern of the at least one directional antenna, and the transmission power of the at least one directional antenna.

6. The mesh node of claim 1, further comprising:
an antenna direction adjusting unit to adjust a direction of the at least one directional antenna,
wherein the processor determines the direction of each of the at least one directional antenna based on a topology, and controls the antenna direction adjusting unit based on the determined direction, and
the topology includes information about at least one neighboring mesh node adjacent to each of a plurality of mesh nodes included in the cognitive radio mesh network.

7. A method of operating a cognitive radio mesh node using a geolocation database, the method comprising:
determining at least one of whether the mesh node is a gateway node, whether the mesh node has an Internet connection, and whether the mesh node is connected to at least one neighboring mesh node adjacent to the mesh node;
enabling an Internet connection of the mesh node based on the determined result;
connecting the mesh node to the at least one neighboring mesh node based on the determined result and the geolocation database; and
maintaining a connection between the mesh node and the at least one neighboring mesh node based on the determined result and the geolocation database,
wherein the geolocation database is accessed via an Internet, and includes information about a plurality of present users located in a service area of a cognitive radio mesh network.

8. The method of claim 7, wherein the enabling of the Internet connection comprises:
sensing a beacon signal transmitted by one of the at least one neighboring mesh node adjacent to the mesh node;
transmitting information about a channel being used by at least one neighboring mesh node adjacent to the mesh node to the neighboring mesh node transmitting the beacon signal, based on the sensing result;
receiving a response associated with the determining of the channel from the neighboring mesh node transmitting the beacon signal; and
enabling the Internet connection of the mesh node based on the received response.

9. The method of claim 7, wherein each of the connecting to the at least one neighboring mesh node and the maintaining of the connection comprises:
obtaining a plurality of available channels between the mesh node and a neighboring mesh node to be connected to, using the geolocation database;
selecting one of the plurality of available channels by excluding a channel being used by at least one neighboring mesh node adjacent to the mesh node;
transmitting, using the selected channel, a beacon signal to the neighboring mesh node to be connected to;
receiving information about a channel being used by at least one neighboring mesh node adjacent to the neighboring mesh node to be connected to from the neighboring mesh node to be connected to; and
determining a channel between the mesh node and the neighboring mesh node to be connected to, based on the received information.

10. The method of claim 9, wherein the connecting to the at least one neighboring mesh node further comprises determining whether the mesh node is connected to the at least one neighboring node, and
the maintaining of the connection further comprises determining whether the connection between the mesh node and the at least one neighboring node is available.

11. The method of claim 7, wherein the mesh node includes at least one directional antenna, and
the connecting to the at least one neighboring mesh node further comprises connecting to the at least one neighboring mesh node based on at least one of a direction of the at least one directional antenna, a width of a beam radiated by the at least one directional antenna, a radiation pattern of the at least one directional antenna, and a transmission power of the at least one directional antenna, and the maintaining of the connection further comprises maintaining the connection based on at least one of a direction of the at least one directional antenna, a width of a beam radiated by the at least one directional antenna, a radiation pattern of the at least one directional antenna, and a transmission power of the at least one directional antenna.

12. The method of claim 11, further comprising:
determining a direction of each of the at least one directional antenna based on a topology,
wherein the topology includes information about the at least one neighboring mesh node adjacent to the mesh node.
